(19) United States
(12) Patent Application Publication
(10) Pub. No.: US 2004/0040196 A1
(43) Pub. Date: Mar. 4, 2004

(54) Measuring tape for use with a fishing net

(76) Inventor: Steven S. Schwartz, Denver, CO (US)

Correspondence Address: DORR CARSON SLOAN & BIRNEY, PC, 3010 EAST 6TH AVENUE, DENVER, CO, 80206

(21) Appl. No.: 10/640,064

(22) Filed: Aug. 13, 2003

Related U.S. Application Data
(60) Provisional application No. 60/407,541, filed on Aug. 30, 2002.

(51) Int. Cl. A01K 77/00; G01B 3/10

(52) U.S. Cl. 43/11; 33/768

(57) ABSTRACT

A retractable measuring tape can be removably attached to the handle of a fishing net adjacent to the proximal end of the net. The measuring tape can be extended to measure a fish laying in the net submerged under water. With the tape measure secured to the net handle, it is always available for use and makes the measurement process convenient and efficient. The measuring tape has opposing lateral straps that extend laterally outward to wrap around the handle of a fishing net. The ends of the straps can be removably secured together by means of Velcro® or other types of adjustable fasteners. A third strap extends perpendicular to the lateral straps through the net opening. The end of the third strap can be removably secured to the lateral straps by means of Velcro® or other types of adjustable fasteners.

### RELATED APPLICATION

The present application is based on, and claims priority to the Applicant's U.S. Provisional Patent Application Ser. No. 60/407,541, entitled “Measuring Tape For Use With A Fishing Net,” filed on Aug. 30, 2002.

### BACKGROUND OF THE INVENTION

1. Field of the Invention

The present invention relates generally to the field of equipment for sports fishing. More specifically, the present invention discloses a measuring tape for use with a fishing net.

2. Statement of the Problem

It can be difficult, inconvenient, and awkward to measure the length of a fish after it has been caught. Many fishing spots are subject to regulations concerning the size of fish that must be returned to the water. Many fisherman also practice catch-and-release fishing in the interest of conservation, but may wish to know the length of a particular fish that has been caught. In either case, it is important to be able to measure a fish as quickly and as safely as possible and with as little handling as possible, to minimize trauma to the fish before its release.

The prior art in this field includes several approaches to measuring fish. For example, many fishing tackle boxes include a measurement scale. A fisherman can measure a fish by holding it adjacent to the measurement scale on the lid of the tackle box. Some fishing nets include a measurement scale on the net handle. Here again, the fish must first be removed from the net and held adjacent to the measurement scale. In addition, the maximum size of the fish that can be measured is limited by the length of the measurement scale.

A conventional measuring tape or ruler can also be used. However, the limitation of having only two hands typically requires two people (one to hold and one to measure), or setting the fish and the net on the ground while attempting to position the measuring tape or ruler next to the fish. This increases the amount of time that the fish remains out of water and also increases the risk of trauma to the fish. The situation is further complicated if the fish is thrashing about in the net. In addition, touching or handling fish can remove the protective film of mucous on the fish, thus causing the growth of a fungus condition which can be fatal.

3. Solution to the Problem

The present invention addresses this problem by providing a retractable measuring tape that can be readily attached to the handle of a conventional fishing net and extended to conveniently and safely measure fish in the fishing net. The measuring tape is stored and transported on the unused section of the net handle and is always ready for use. As a result, fish can be measured and released in less time, with more efficiency, and with less contact with the fish. Its adjustable design fits virtually all nets. The present invention enables the angler to measure fish without removing them from the water. For catch and release purposes, a fish can be measured while it remains partially submerged by gently cradled with one hand under the net, thus reducing stress and handling. The angler can extend the tape measure with the other hand, thereby allowing the angler to easily measure fish without the need for assistance. Fish that are longer than the net can also be measured in the same manner. The present invention also eliminates the need for an angler to carry a separate measuring device.

### SUMMARY OF THE INVENTION

This invention provides a retractable measuring tape that can attached to the handle of a fishing net adjacent to the proximal end of the net. The measuring tape can be extended to measure a fish laying in the net submerged under water. The measuring tape has opposing lateral straps that extend laterally outward to wrap around the handle of a fishing net. The ends of the straps can be removably secured together by means of Velcro® or other types of adjustable fasteners. A third strap extends perpendicular to the lateral straps through the net opening. The end of the third strap can be removably secured to the lateral straps by means of Velcro® or other types of adjustable fasteners.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of the present invention attached to the handle of a fishing rod.

FIG. 2 is a detail perspective view of the device with the measuring tape 30 extended.

FIG. 3 is a top plan view of the device.

FIG. 4 is a side view of the device.

FIG. 5 is a bottom view of the device.

FIG. 6 is a rear view of the device.

FIG. 7 is a perspective view of the device attached to the handle of a fishing net with the measuring tape 30 extended to measure a fish 10 in the net 20.

### DETAILED DESCRIPTION OF THE INVENTION

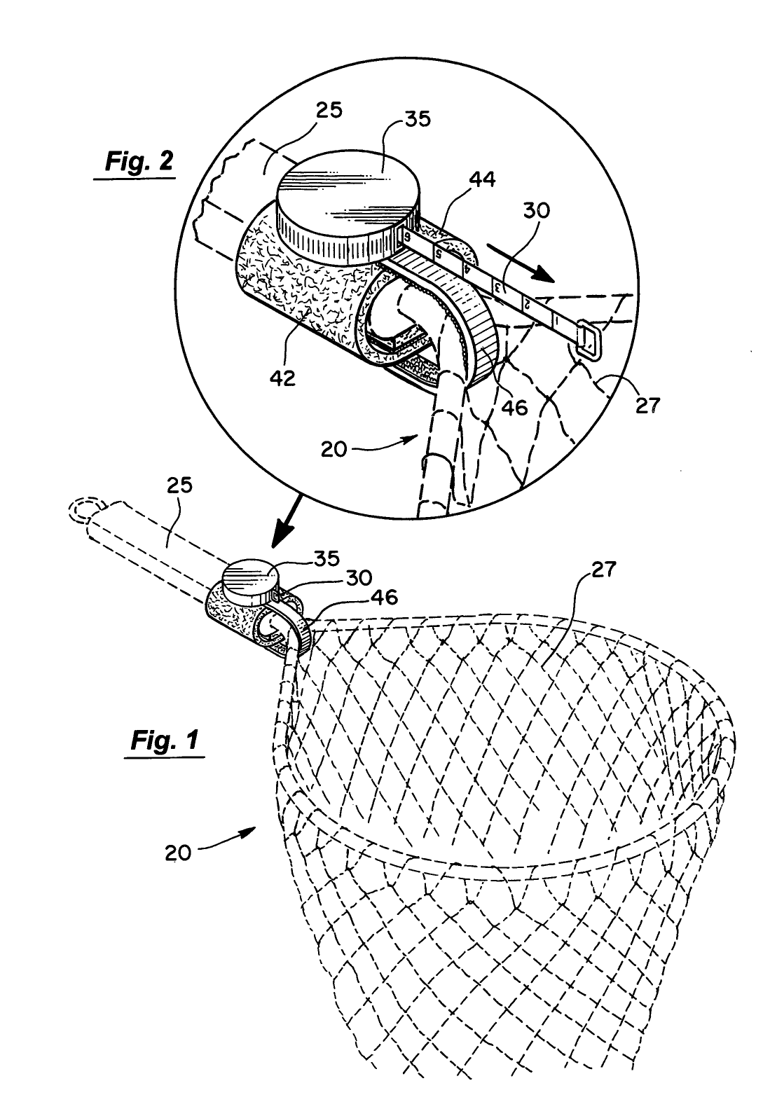

Turning to FIG. 1, a perspective view is provided of the present invention attached to the handle 25 of a fishing net 20. The major components are a retractable measuring tape 30, and a number of straps 42, 44, and 46 that enable the measuring tape 30 to be removably secured to the handle 25 adjacent to the proximal end of the net 20.

As shown in FIG. 2, the measuring tape 30 has a housing 35 containing a spring-loaded reel that allows the tape 30 to be manually extended to measure a fish 10 laying in the net 20, and retracted into the housing for storage when the tape is not in use. The tape can be marked in the conventional manner in inches or centimeters. The measuring tape 30 should have a maximum length (e.g., approximately 36 inches) sufficient to measure the types of fish (e.g., trout, bass, perch, and walleye) that are commonly caught by sports fishermen and landed with a net 20. The components of the measuring tape 30 should preferably be made of plastic or other corrosion-resistant materials to prevent rust.

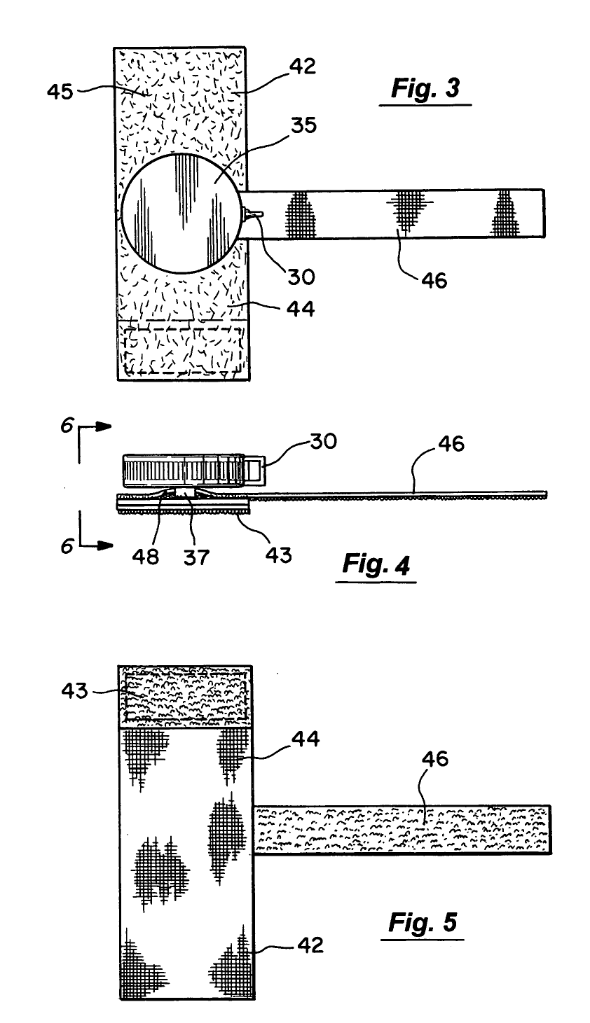

A number of flexible straps 42, 44, and 46 are employed to attach the measuring tape 30 to the fishing net handle 25. In the preferred embodiment, there are three straps 42, 44, and 46 made of cloth or flexible plastic, as depicted in the orthogonal views provided in FIGS. 3 through 6. Two opposing lateral straps 42 and 44 extend laterally outward from the measuring tape 30 and wrap around the handle 25 of the fishing net 20. The third strap 46 extends perpendicular to the lateral straps 42, 44 passes through the net opening adjacent to the handle 25. This third strap 46 holds the measuring tape 30 at a position on the net handle 25 close to the proximal end of netting 27, and prevents the measuring tape 30 from inadvertently sliding down the net handle 25.

It should be expressly understood that other strap configurations could be readily substituted. For example, a single strap of material could be used to encircle the handle 25 of the fishing net 20. Multiple sets of complementary straps could also be used. The straps can be made of an elastic or stretchable material to accommodate a wide range of handle sizes.

The ends of the lateral straps 42, 44 can be removably secured to one another by means of fasteners 43 and 45, so that the lateral straps 42, 44 encircle the net handle 25. In the preferred embodiment, these lateral strap fasteners 43, 45 are hook-and-loop fasteners (e.g., Velcro® material). However, other types of fasteners, such as snaps, adhesives, zippers, or hook-and-eye fasteners could be readily substituted.

Similarly, the end of the third strap 46 is removably secured by means of a fastener 47 to at least one of the lateral straps 42, 44. As before, this third strap fastener 47 can be hook-and-loop material that engages a complementary patch of hook-and-loop material on the exposed surface of one of the lateral straps 42, 44. Alternatively, other types of fasteners could be readily substituted. In the preferred embodiment of the present invention, these fasteners 43, 45, and 47 provide a degree of adjustability to accommodate a range of net handle dimensions and diameters.

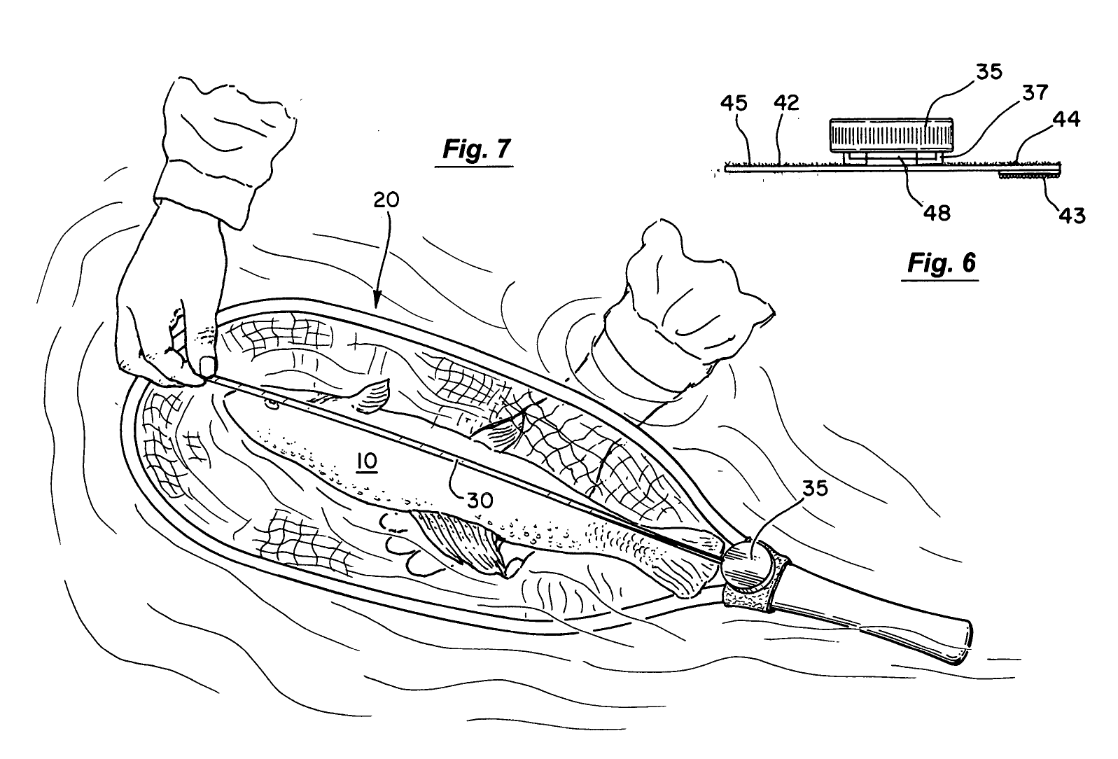

The measuring tape 30 can be attached to the straps 42, 44, 46 by any of a variety of means, such as adhesive, snaps, rivets, or the like. In the preferred embodiment, a bar 37 extends across the back of the reel housing 35 with a small spacing between the bar 37 and rear face of the housing 35, as shown in FIG. 6. A flexible mounting strap 48 passes through this space, and both ends of the mounting strap 48 are anchored to the lateral straps 42, 44. This configuration secures the measuring tape 30 to the lateral straps 42, 44 but allows the measuring tape to swivel to a degree relative to the lateral straps 42, 44. This is helpful in allowing the measuring tape to be extended over a wider range of angles. For example, the measuring tape can be used to measure objects that are not in the net.

To use the present invention, the tape measure 30 must first be attached to the handle 25 of a fishing net 20. The angler holds the tape measure against the desired location on the net handle 25 while simultaneously wrapping the lateral straps 42, 44 around the net handle 25. The angler should also exert a compressive force on the hook-and-loop fasteners 43, 45 to ensure a firm connection between the lateral straps 42, 44. The angler then inserts the loose end of the third strap 46 through the net opening adjacent to the handle 25. The hook-and-loop fastener 47 on the end of the third strap is then secured to outer surface of one of the lateral straps 43, 45 to complete the installation, as shown in FIGS. 1 and 2. The tape measure can be removed at any time by reversing this process.

After a fish has been caught in the net 20, the angler gently cradles both the net 20 and fish 10 with one hand, as shown in FIG. 7. The fish 10 can be held generally parallel to the surface of the water and partially submerged to minimize trauma to the fish. The fish can then be measured by extending the tape from the reel housing 35 with the other hand, as shown in FIG. 7. For accurate measurement, the tape should extend parallel to the length of the fish 10. The angler can determine the length of a fish by reading the markings on the tape. Thus, the angler can accurately, quickly, and conveniently measure the fish's length without assistance and with minimal contact to the fish. In most cases, the fish will fit completely within the net 20. However, a particular large fish that extends beyond the net can still be measured by extending the tape as far as needed to reach the distal end of the fish.

The above disclosure sets forth a number of embodiments of the present invention. Other arrangements or embodiments, not precisely set forth, could be practiced under the teachings of the present invention and as set forth in the following claims.

I claim:

1. A measuring tape assembly for removable attachment to a fishing net having a handle and a net opening, said retractable measuring tape comprising:
a retractable measuring tape;
at least one lateral strap extending from the measuring tape to encircle the handle of a fishing net; and
a third strap extending from the lateral strap through the net opening, and having an end removably securable to the lateral strap.

2. The measuring tape assembly of claim 1 wherein the lateral strap comprises opposing straps extending laterally outward from the measuring tape to encircle the handle of a fishing net, and having ends that can be removably secured together.

3. The measuring tape assembly of claim 2 wherein the ends of the lateral straps are fastened with hook-and-loop fasteners.

4. The measuring tape assembly of claim 1 wherein the end of the third strap is fastened to the lateral strips with hook-and-loop fasteners.

5. The measuring tape assembly of claim 1 wherein the lateral strap is elastic.

6. The measuring tape assembly of claim 1 wherein the third strap is elastic.

7. The measuring tape assembly of claim 1 further comprising:
a bar attached to the measuring tape; and
a mounting strap passing through the space between the bar and the measuring tape, and having ends anchored to the lateral strap, thereby securing the measuring tape to the lateral strap.

8. A measuring tape assembly for removable attachment to a fishing net having a handle and a net opening, said retractable measuring tape comprising:
a retractable measuring tape having a housing;
a bar extending across the measuring tape and spaced a distance from the housing of the measuring tape;
at least one lateral strap extending from the measuring tape to encircle the handle of a fishing net;
a mounting strap passing through the space between the bar and the measuring tape, and having ends anchored to the lateral strap, thereby securing the measuring tape to the lateral strap; and
a third strap extending from the lateral strap through the net opening, and having an end removably securable to the lateral strap.

9. The measuring tape assembly of claim 8 wherein the lateral strap comprises opposing straps extending laterally outward from the measuring tape to encircle the handle of a fishing net, and having ends that can be removably secured together.

10. The measuring tape assembly of claim 9 wherein the ends of the lateral straps are fastened with hook-and-loop fasteners.

11. The measuring tape assembly of claim 8 wherein the end of the third strap is fastened to the lateral strips with hook-and-loop fasteners.

12. The measuring tape assembly of claim 8 wherein the lateral strap is elastic.

13. The measuring tape assembly of claim 8 wherein the third strap is elastic.

14. A measuring tape assembly for removable attachment to a fishing net having a handle and a net opening, said retractable measuring tape comprising:
a retractable measuring tape;
opposing lateral straps extending from the measuring tape to encircle the handle of a fishing net, and having ends that can be removably secured together; and
a third strap extending from the lateral straps through the net opening, and having an end removably securable to the lateral straps.

15. The measuring tape assembly of claim 14 wherein the ends of the lateral straps are fastened with hook-and-loop fasteners.

16. The measuring tape assembly of claim 14 wherein the end of the third strap is fastened to the lateral strips with hook-and-loop fasteners.

17. The measuring tape assembly of claim 14 wherein the lateral straps are elastic.

18. The measuring tape assembly of claim 14 wherein the third strap is elastic.

19. The measuring tape assembly of claim 14 further comprising:
a bar extending across the measuring tape and spaced a distance from the measuring tape; and
a mounting strap passing through the space between the bar and the measuring tape, and having ends anchored to the lateral straps, thereby securing the measuring tape to the lateral straps.
